(19) United States
(12) Patent Application Publication
(10) Pub. No.: US 2012/0092370 A1
(43) Pub. Date: Apr. 19, 2012

(54) APPARATUS AND METHOD FOR AMALGAMATING MARKERS AND MARKERLESS OBJECTS

(75) Inventors: Ik Sung OH, Seongnam-si (KR); Dae Heum KIM, Goyang-si (KR); Seong Il KIM, Seoul (KR); Chan Joo PARK, Seoul (KR); Jong Hyuk EUN, Seoul (KR); Eun Mi RHEE, Seoul (KR); Kyeong Min CHOI, Seoul (KR); Ki Soo CHOI, Seoul (KR)

(73) Assignee: PANTECH CO., LTD., Seoul (KR)

(21) Appl. No.: 13/196,771

(22) Filed: Aug. 2, 2011

(30) Foreign Application Priority Data
Oct. 13, 2010 (KR) 10-2010-0100022

(51) Int. Cl. G09G 5/00

(52) U.S. Cl. 345/633

(57) ABSTRACT

An apparatus to provide AR includes a marker recognition unit to recognize objects in reality information, an amalgamation determining unit to determine whether the objects are amalgamated, an amalgamation processing unit to determine an attribute of each of the recognized objects and to generate an amalgamated object based on the determined attributes, and an object processing unit to map the amalgamated object to the reality information and to display the mapped amalgamated object. A method for amalgamating objects in AR includes recognizing objects in reality information, determining whether the objects are amalgamated, determining an attribute of each of the recognized objects, generating an amalgamated object based on the determined attribute, mapping the amalgamated object to the reality information, and displaying the mapped amalgamated object.

### CROSS-REFERENCE TO RELATED APPLICATION

This application claims priority from and the benefit under 35 U.S.C. §119(a) of Korean Patent Application No. 10-2010-0100022, filed on Oct. 13, 2010, which is hereby incorporated by reference for all purposes as if fully set forth herein.

### BACKGROUND

1. Field

This disclosure relates to apparatus to provide augmented reality (AR) and method thereof, and more particularly, to apparatus to provide AR and a method for amalgamating two or more objects and displaying an amalgamated object in AR.

2. Discussion of the Background

An augmented reality (AR) technology is one of virtual reality technologies that are available to combine an image of a real world environment, which a user may see with his or her eyes, with virtual world information to display a combined image or an amalgamated image. The AR technology is based on a concept for supplementing the real world images with virtual information. More specifically, the AR technology may use a virtual information display created by a computer visualization technique, in which the virtual information may be based on a real world environment. The computer visualization technique may provide additional information, which may not be readily available in the real world, to the real world environment. However, this integration of virtual information with real world environment may lead to difficulty in distinguishing between the real-world environment and the virtual environment. More specifically, the difficulty may be attributed to the computer graphic technique overlapping a three-dimensional virtual image upon a real image.

The AR technology may immerse the user in the virtual environment so the user may have difficulty separating the real-world environment from the virtual one. The AR technology may be implemented so that a computer may recognize a predetermined marker to display a three-dimensional graphic model mapped to a marker on a monitor in response. Here, the marker may exist on a two-dimensional flat plane, and the marker alone may provide size, direction and location information of a three-dimensional graphic model mapped to the marker. The marker and the three-dimensional graphic model may be displayed on an output device including a monitor. The marker and the three-dimensional graphic model may vary depending on selection of the user.

Conventionally, because each three-dimensional graphic model corresponds to a single marker as described above, markers may not affect each other even if the markers are related to each other. That is, there is a lack of interaction between the markers.

### SUMMARY

Exemplary embodiments of the present invention provide an apparatus to provide augmented reality (AR) and a method for amalgamating markers or markerless object.

Additional features of the invention will be set forth in the description which follows, and in part will be apparent from the description, or may be learned by practice of the invention.

Exemplary embodiments of the present invention provide an apparatus to provide AR including a marker recognition unit to recognize a first object and a second object in reality information, an amalgamation determining unit to determine whether the first object and the second object are amalgamated, an amalgamation processing unit to determine an attribute of each of the recognized objects using an amalgamation pattern of the recognized objects, and to generate an amalgamated object based on the determined attributes, and an object processing unit to map the amalgamated object to the reality information and to display the mapped amalgamated object.

Exemplary embodiments of the present invention provide a method for amalgamating objects in AR, the method including recognizing a first object and a second object in reality information, determining whether the first object and second object are amalgamated, determining an attribute of each of the recognized objects using an amalgamation pattern of the recognized objects and object information of the recognized objects, generating an amalgamated object based on the determined attribute, mapping the amalgamated object to the reality information, and displaying the mapped amalgamated object.

Exemplary embodiment of the present invention discloses a method for amalgamating objects in AR, the method including recognizing a first object and a second object in reality information, in which reality information includes a location information associated with a real-world, the location information comprising at least one of an address, a geographic location, an image of the real-world, and a travel direction to identify a location in the real-world; determining whether the first object and second object are amalgamated; determining an attribute of each of the recognized objects using an amalgamation pattern of the recognized objects, in which the attribute of the first object or the second object includes at least one of a priority, a feature of the object, and a relationship with the other object; determining a process of the amalgamated object based on the determined attribute; generating an amalgamated object based on the determined attribute; mapping the amalgamated object to the reality information; and displaying the mapped amalgamated object.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a structure of an apparatus to provide augmented reality to amalgamate multiple objects according to an exemplary embodiment of the invention.

FIG. 2 is a flowchart illustrating a process for amalgamating markers or markerless objects, and for outputting an amalgamated object on an apparatus to provide AR according to an exemplary embodiment of the invention.

FIG. 3 illustrates an amalgamation pattern of markers or markerless objects in an apparatus to provide AR according to an exemplary embodiment of the invention.

FIG. 4 illustrates a color change process and a menu change process of an amalgamation object in an apparatus to provide AR based on a temporal factor according to an exemplary embodiment of the invention.

FIG. 5 illustrates amalgamation between a marker indicating a coupon and a markerless object indicating a building in an apparatus to provide AR according to an exemplary embodiment of the invention.

FIG. 6 illustrates amalgamation of multiple objects based on position of the objects with respect to each other in an apparatus to provide AR according to an exemplary embodiment of the invention.

FIG. 7 illustrates attribute and process information of each object used to assemble an amalgamated object in an apparatus to provide AR according to an exemplary embodiment of the invention.

FIG. 8 illustrates amalgamation of objects based on movement and the rate of movement of the objects in an apparatus to provide AR according to an exemplary embodiment of the invention.

FIG. 9 illustrates amalgamation of objects based on sizes of the objects in an apparatus to provide AR according to an exemplary embodiment of the invention.

FIG. 10 illustrates amalgamation of objects based on a recognition order of the objects in an apparatus to provide AR according to an exemplary embodiment of the invention.

FIG. 11 illustrates amalgamation of objects based on a physical arrangement of the objects in an apparatus to provide AR according to an exemplary embodiment of the invention.

FIG. 12 illustrates amalgamation of objects based on a physical arrangement of the objects in an apparatus to provide AR according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ). Throughout the drawings and the detailed description, unless otherwise described, the same drawing reference numerals are understood to refer to the same elements, features, and structures. The relative size and depiction of these elements may be exaggerated for clarity, illustration, and convenience.

The exemplary embodiments of the present invention may provide an augmented reality (AR) apparatus and a method for amalgamating two or more objects to assemble an amalgamated object and displaying the amalgamated object in AR. In an example, the objects being combined to assemble the amalgamated objects may include a combination of a marker and markerless object. Without limitation, the combination of amalgamated objects may include combination of a marker with another marker, a marker with a markerless object, or a markerless object with another markerless object.

A marker may refer to an AR tag, which may include virtual information associated with a real world object. In addition, the marker may also refer to other virtual objects found in AR. A markerless object may refer to an object in a real world without an associated virtual marker. For example, amalgamated object may include a markerless object, such as a Starbucks® coffee shop and an associated marker, which may be an AR tag including virtual information related to the Starbucks® coffee shop, such as hours of operation, location, and possible promotions.

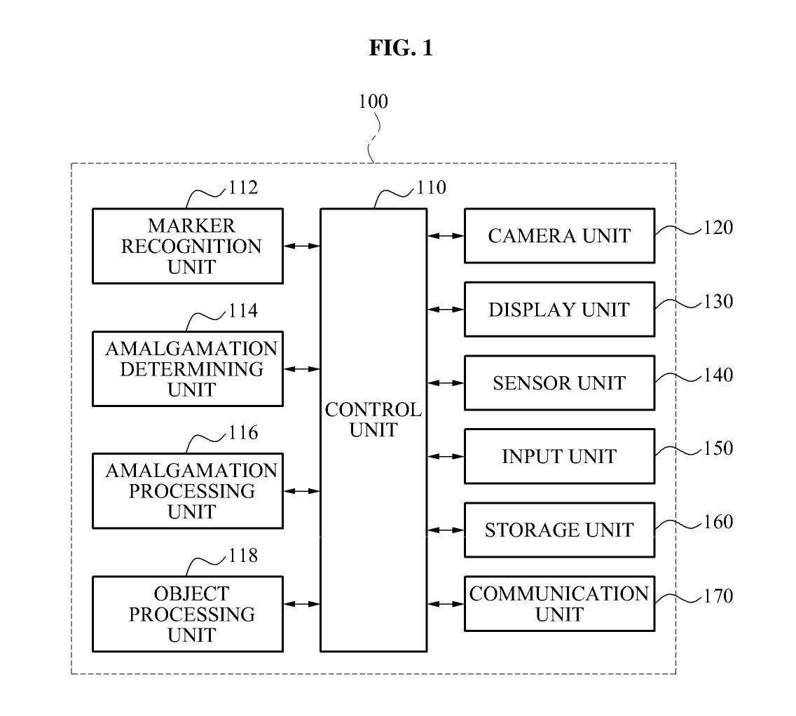

FIG. 1 is a block diagram illustrating a structure of an apparatus 100 to provide AR to amalgamate multiple objects according to an exemplary embodiment of the invention.

As shown in FIG. 1, the apparatus 100 according to aspects of the present invention includes a control unit 110, a marker recognition unit 112, an amalgamation determining unit 114, an amalgamation processing unit 116, an object processing unit 118, a camera unit 120, a display unit 130, a sensor unit 140, an input unit 150, a storage unit 160, and a communication unit 170.

The camera unit 120 may be a photographing device, which may provide reality information, for example, an image or a preview image of the real-world to the marker recognition unit 112 and the display unit 130. In this instance, the image may be corrected through image correction before the image is provided to the marker recognition unit 112 and the display unit 130. Also, the preview image may be corrected through camera correction before the image is provided to the marker recognition unit 112 and the display unit 130.

The display unit 130 may display status information of the apparatus 100, numbers, characters, a moving picture, and a still picture that may be obtained during operation of the apparatus 100. Also, the display unit 130 may display an image including a markerless object received through the camera unit 120, and may additionally display related AR information or associated markers in AR.

The sensor unit 140 may sense additional information used to provide AR, such as contextual information applied to the AR. In an example, the sensor unit 140 may include at least one of a temperature sensor, a humidity sensor, a location sensor, and an orientation measuring sensor. The location sensor may be a global positioning system (GPS) sensor for sensing a GPS signal, and the orientation measuring sensor may be a gyroscope or an accelerometer sensor.

The input unit 150 may receive a user input, and may provide the received user input to the control unit 110. The input unit 150 may have one or more input keys including number keys of 0 to 9, a menu key, a delete key, a confirm key, a call key (TALK), an end key (END), an Internet access key, a navigation key, and the like. Further, the input unit 150 may constitute a key pad to provide the control unit 110 with key input data corresponding to a pressed key. Further, the input unit 150 may be combined with the display unit 130 as a touchscreen display.

The storage unit 160 may store an operating system to control the entire operation of the apparatus 100, an application program, and data for storage. Data for storage may include a telephone number, a short message service (SMS) message, a compressed image file, a moving image, and the like. The storage unit 160 may also include an AR database that may store an AR object or information corresponding to a marker or a markerless object. Further, the AR database may also store attribute information and object information of the AR object.

The communication unit 170 may transmit and receive data using a wired network or a wireless network. In addition, the communication unit 170 may communicate with an AR server to store information and to manage the AR database. Here, the AR database may be a database to store an AR object corresponding to a marker or a markerless object, and to store attribute information of the AR object.

The marker recognition unit 112 may recognize an object, whether they are a marker or a markerless object in an image or a preview image taken or captured by the camera unit 120. The marker recognition unit 112 may recognize a marker or a markerless object in an image or a preview image by searching the AR database of the storage unit 160 or the AR database of an AR server that may be detected through the communication unit 170. The marker recognition unit 112 may recognize a marker or a markerless object at an area designated by a user in an image or a preview image. If the marker recognition unit 112 recognizes a marker or a markerless object at an area designated by the user, processing load on the apparatus 100 may be reduced.

If at least two objects, whether they are markers or markerless objects, are recognized by the marker recognition unit 112, the amalgamation determining unit 114 may determine whether the recognized objects are amalgamated. The amalgamation determining unit 114 may make such a determination using an amalgamation pattern of the markers or markerless objects and their respective object information. Object information may refer to information associated with the individual object, whether it is a marker or a markerless object. In an example, if an object was a business, object information may include name of the object, hours of operation, contact information, and other relevant information. Further, if an object was a coupon, object information may include amount of the discount, locations where coupons may be accepted, coupon expiration date, and any limitations that may be imposed on the respective coupon.

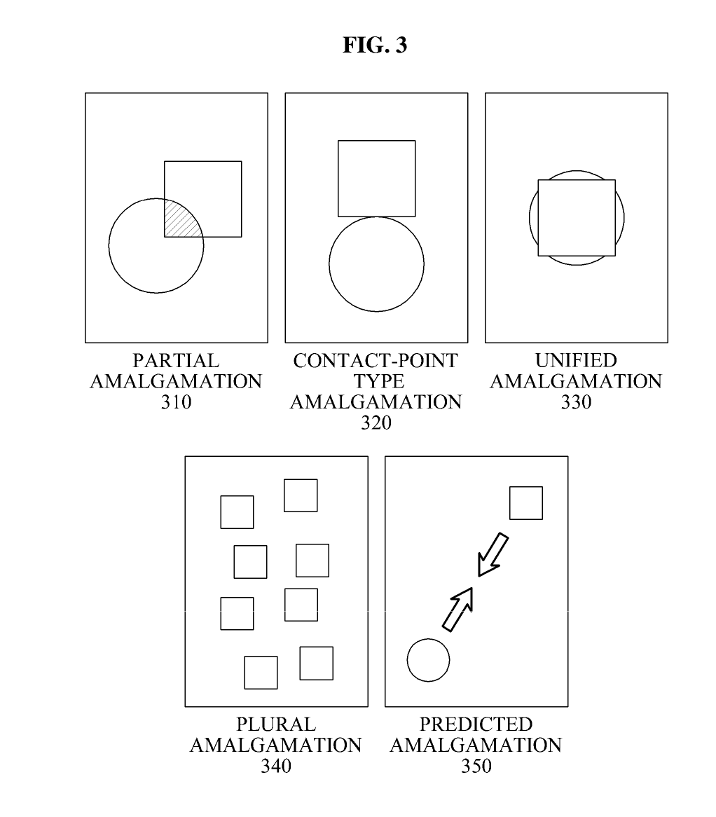

The amalgamation pattern of the markers or markerless objects used to determine amalgamation by the amalgamation determining unit 114 is described below with reference to FIG. 3.

FIG. 3 illustrates an amalgamation pattern of markers or markerless objects in the apparatus to provide AR according to an exemplary embodiment of the invention.

As shown in FIG. 3, an amalgamation pattern of markers or markerless objects includes partial amalgamation 310, contact point-type amalgamation 320, unified amalgamation 330, plural amalgamation 340, and predicted amalgamation 350. The partial amalgamation 310, the contact point-type amalgamation 320, and the unified amalgamation 330 may be determined based on proximity in distance between the markers or markerless objects, or based on a combination of the markers or markerless objects. The plural amalgamation 340 may be determined based on arrangement of the markers or markerless object. The predicted amalgamation 350 may be determined based on a moving direction and a moving rate of the markers or markerless objects. While various examples of amalgamation patterns are provided in FIG. 3, the illustrated patterns are provided for ease of illustration and are not limited to these examples.

Also, the amalgamation pattern of markers or markerless objects may further include sequential amalgamation (not shown) based on a recognition order of the markers or markerless objects. In an example, the recognition order of the markers and marker less objects may correspond to a photographing or capturing order of images.

If the amalgamation determining unit 114 determines that the markers or markerless objects are amalgamated, the amalgamation processing unit 116 may generate an amalgamated object using an amalgamation pattern of the recognized objects. Further, by using object information of the recognized objects, the amalgamation processing unit 116 may determine a process of the amalgamated object. In an example, if a first object is a person and a second object is a ball, which is amalgamated at the person's foot, the process of the amalgamated object may be a person kicking the ball. In another example, if the amalgamated object is made up of a person as the first object and a taxi cab as the second object, the process of the amalgamated object maybe to display the routes for the taxi cab.

In addition, the amalgamation processing unit 116 may generate an amalgamated object based on a received user input or received contextual information. In an example, the amalgamation processing unit 116 may receive the user input through the input unit 150 or receive the contextual information through the sensor unit 140. Based on the received user input or contextual information, the amalgamation processing unit 116 may determine a process of the amalgamated object.

If the amalgamation processing unit 116 generates an amalgamated object, the amalgamation processing unit 116 may determine an attribute of the amalgamated objects using an amalgamation pattern of the markers or markerless objects and object information of the markers or markerless objects. In addition, the amalgamation processing unit 116 may determine a process of the amalgamated object based on the determined attribute. In an example, the attribute of the object may include priority, a feature of the object, and a relationship with other object.

Also, the amalgamation processing unit 116 may store amalgamation information of the amalgamated object in an AR database of the storage unit 160 or an AR database of an AR server that communicates with the communication unit 170. Here, the amalgamation information may include amalgamation pattern information, attribute information of the amalgamated object, the amalgamated object, and process information of the amalgamated object.

The object processing unit 118 may map an amalgamated object to reality information and may display the mapped amalgamated object in a real-world setting. In an example, reality information may include location information associated with the real-world, such as an address, a geographic location, images of a particular location, travel directions to a location in a real-world environment, and other related information. Accordingly, once the amalgamated object is mapped to reality information, the amalgamated object may be displayed with respect to a real-world environment.

The control unit 110 may control the entire operation of the apparatus 100 to amalgamate markers or markerless objects. Also, the control unit 110 may perform processes of the marker recognition unit 112, the amalgamation determining unit 114, the amalgamation processing unit 116, and the object processing unit 118. The present exemplary embodiment describes processes of the control unit 110, the marker recognition unit 112, the amalgamation determining unit 114, the amalgamation processing unit 116, and the object processing unit 118 distinctively for ease of description. Accordingly, the control unit 110 may perform processes of the marker recognition unit 112, the amalgamation determining unit 114, the amalgamation processing unit 116, and the object processing unit 118 in actual products. Also, the control unit 110 may perform a portion of the processes of the marker recognition unit 112, the amalgamation determining unit 114, the amalgamation processing unit 116, and the object processing unit 118 in actual products.

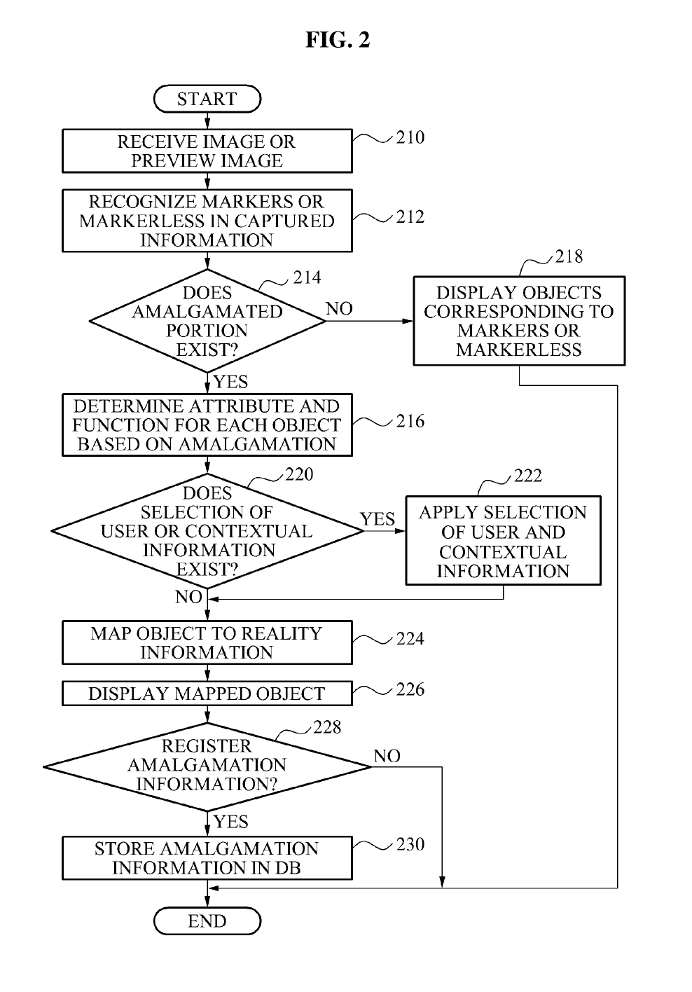

Hereinafter, a method for amalgamating markers or markerless objects according to an exemplary embodiment of the present invention is described with reference to FIG. 2.

FIG. 2 is a flowchart illustrating a process for amalgamating markers or markerless objects, and for outputting an amalgamated object on an apparatus according to an exemplary embodiment of the invention.

Referring to FIG. 2, in operation 210, the apparatus 100 receives an image or a preview image. In an example, the received image may be an image of the real world, which may include at least one of a marker and a markerless object. The image of the real world may be taken or captured by the camera unit 120, or by other suitable device.

In operation 212, the apparatus 100 may recognize one or more markers or markerless objects included in the received image.

In operation 214, if at least two objects are recognized, the apparatus 100 may determine whether the recognized objects are amalgamated. In an example, the recognized objects may be a combination of multiple markers, markerless objects, or a combination of a marker and a markerless object. More specifically, the apparatus 100 may determine whether an amalgamated portion between the markers or markerless objects exists using an amalgamation pattern of the recognized markers or markerless objects and the object information of the recognized markers or markerless objects.

If an amalgamated portion between the markers or markerless objects does not exist in operation 214, the apparatus 100 may display the markers or markerless objects in their original form.

Alternatively, if an amalgamated portion between the markers or markerless objects exists in operation 214, the apparatus 100 may generate an amalgamated object using on an amalgamation pattern of the markers or markerless objects, and using object information of the markers or markerless objects. Further, based on such information, the apparatus 100 may determine attributes of each object and a process of the amalgamated object, in operation 216.

In operation 220, the apparatus 100 may check to determine whether a user input is received, such as a selection of a user, or contextual information is available.

If no user input is received indicating a selection or contextual information is not available, the apparatus 100 proceeds to operation 224.

Alternatively, if a user input, such as a selection of a user, is received or contextual information is available, the apparatus 100 may apply the received selection of the user or the contextual information to the amalgamated object in operation 222.

In operation 224, the apparatus 100 may map the amalgamated object to the reality information.

In operation 226, the apparatus 100 displays the mapped amalgamated object in AR.

In operation 228, the apparatus 100 determines whether to register amalgamation information. In this instance, the determination of whether to register amalgamation information may be preconfigured based on reference conditions or determined in accordance to the received user input.

If it is determined to register amalgamation information in operation 228, the apparatus 100 may store the amalgamation information of the objects in an AR database in operation 230. In an example, the AR database may be a database in the storage unit 160 or an AR database of an AR server. Here, the amalgamation information of the objects may include amalgamation pattern information, attribute information of the objects, information of the amalgamated object, and process information of the amalgamated object.

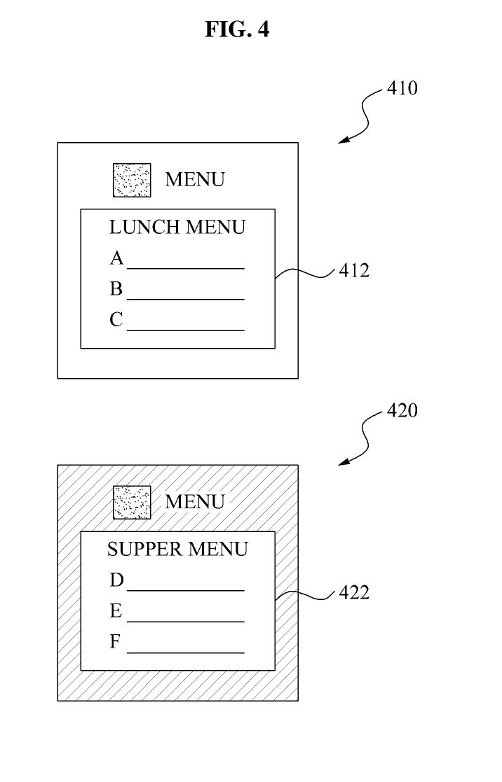

FIG. 4 illustrates a color change process and a menu change process of an amalgamation object in an apparatus based on a temporal factor according to an exemplary embodiment of the invention.

Referring to FIG. 4, the apparatus 100 may enable a process of an amalgamated object to change based on a particular condition. In an example, the color or pattern around a menu marker, as shown in a first amalgamation object 410 and a second amalgamation object 420 may be changed according to a particular condition.

Further, the contents of the menu may also change based on a specific condition, such as time of day. In the first amalgamation example 410, if the time of day is determined as day time, the apparatus 100 may display a lunch menu 412 as an amalgamated object in AR with a corresponding color or pattern to indicate the lunch menu 412.

In the second amalgamation example 420, if time of day is determined as night time, the apparatus 100 may display a supper menu 422 as an amalgamated object in AR with a corresponding color or pattern to indicate the supper menu 422.

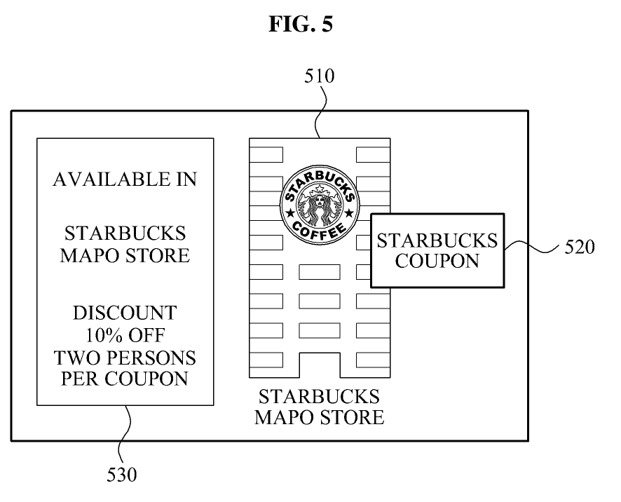

FIG. 5 illustrates amalgamation between a marker indicating a coupon and a markerless object indicating a building in an apparatus according to an exemplary embodiment of the invention.

Referring to FIG. 5, if the apparatus 100 recognizes a markerless object indicating a Starbucks® Mapo store 510 and a marker indicating a Starbucks® coupon 520, the apparatus 100 may amalgamate the markerless object, Starbucks® Mapo store 510, and the marker, Starbucks® coupon 520, to output an amalgamated object 530 indicating the details of the Starbucks® coupon applied to the Starbucks® Mapo store in AR. More specifically, the amalgamated object 530 may display the details of the Starbucks® coupon 520 indicating 10% off discount at the identified markerless object, Starbucks® Mapo store 510. Accordingly, a consumer may determine which Starbucks® store they may want to visit based on the promotion at specific locations.

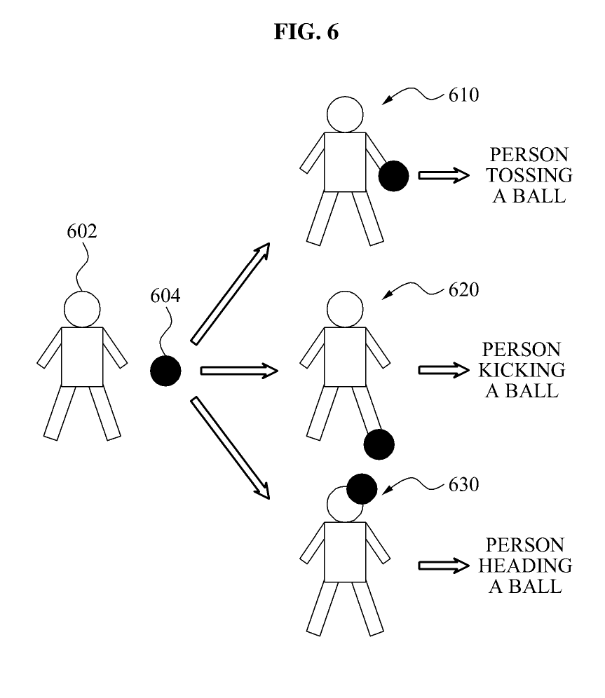

FIG. 6 illustrates amalgamation of multiple objects based on position of the objects with respect to each other in an apparatus to provide AR according to an exemplary embodiment of the invention.

Referring to FIG. 6, the apparatus 100 may enable a process of an amalgamated object to change based on positions of markers. In an example, different information may be provided based on the contact locations of the respective markers. If a marker 602 indicating a person, and a marker 604 indicating a ball are amalgamated at different locations of the maker 602, as shown in a first amalgamation example 610, a second amalgamation example 620, and a third amalgamation example 630, different information may be provided.

According to the first amalgamation example 610, if the ball marker 604 is amalgamated at the hand location of the person marker 602, the apparatus 100 may generate a person tossing a ball as an amalgamated object.

According to the second amalgamation example 620, if the ball marker 604 is amalgamated at the foot location of the person marker 602, the apparatus 100 may generate a person kicking a ball as the amalgamated object.

According to the third amalgamation example 630, if the ball marker 604 is amalgamated at the head location of the person marker 602, the apparatus 100 may generate a person heading a ball as the amalgamated object.

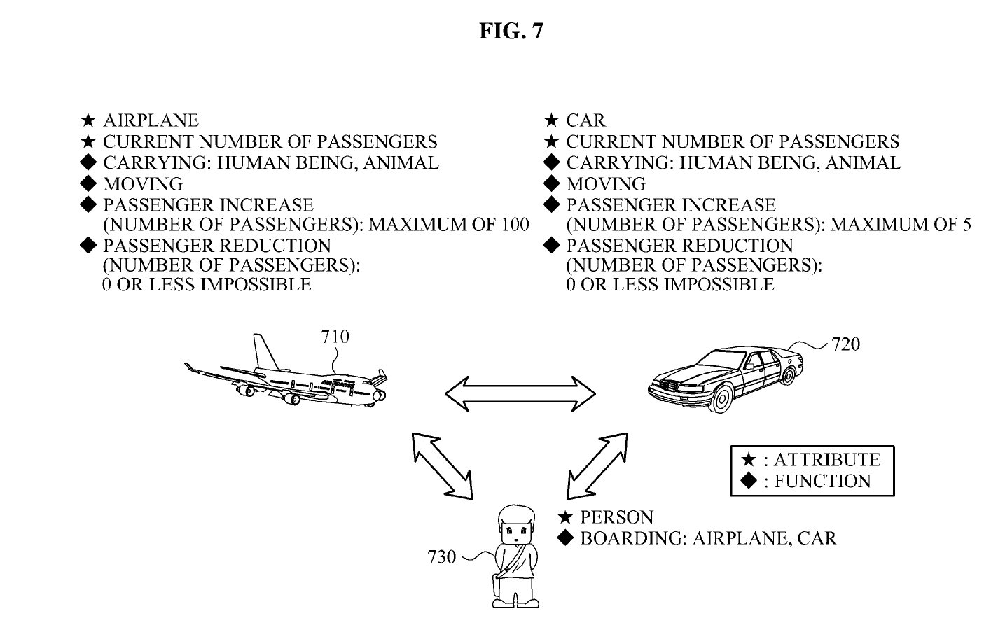

FIG. 7 illustrates attribute and process information of each object used to assemble an amalgamated object in an apparatus according to an exemplary embodiment of the invention.

If the apparatus 100 generates an amalgamated object, the apparatus 100 may determine an attribute of one or more objects making up the amalgamated object using an amalgamation pattern of markers or markerless object. Further, using the determined attributes of the markers or markerless objects, the apparatus 100 may determine a process of the amalgamated object.

Referring to FIG. 7, the apparatus 100 generates an amalgamated object, which may include a combination of an airplane object 710, a car object 720, and a person object 730. Based on how the respective objects are amalgamated, specific process of the amalgamated object may be determined based on the combination of the respective objects and their respective attributes. More specifically, based on a relationship between the airplane object 710, the car object 720, and the person object 730 in the amalgamated form, different information may be provided. For example, if the person object 730 and the airplane object 710 were to be combined to provide an amalgamated object, information providing the types of passengers, maximum number of passengers, and the status of flight may be provided. If the person object 730 and the car object 720 were to be combined, same types of information may be provided, such as the maximum number of passengers, but the information may be different. For example, the maximum number of passengers for the airplane object 710 may be different than the maximum number of passengers for the car object 720.

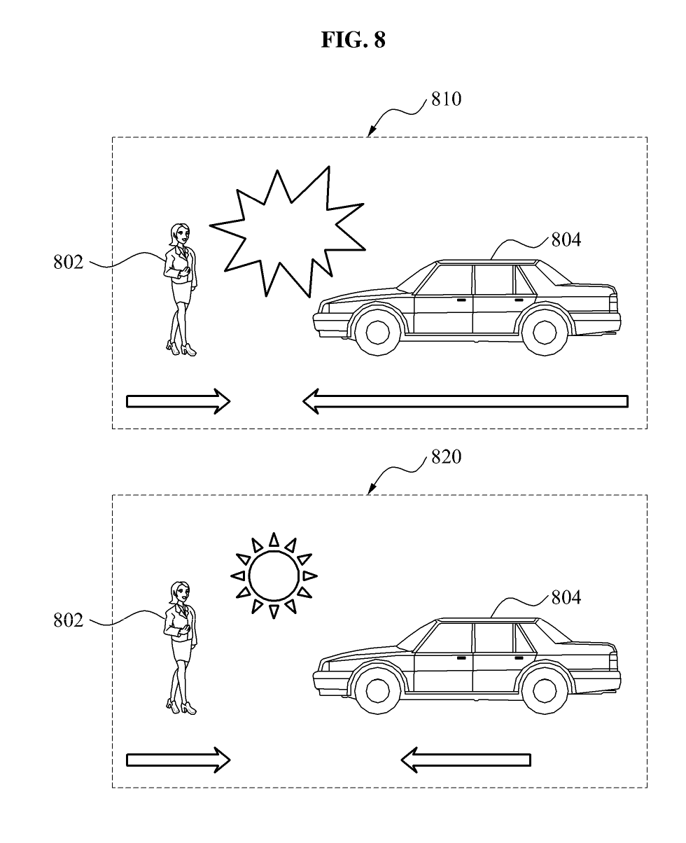

FIG. 8 illustrates amalgamation of objects based on movement and the rate of movement of the objects in an apparatus to provide AR according to an exemplary embodiment of the invention.

Referring to FIG. 8, the apparatus 100 may enable a process of an amalgamated object to change based on a moving direction and a moving rate of an object. In an example, markerless object 802 indicating a person and markerless object 804 indicating a car, are shown in a first amalgamation example 810 and a second amalgamation example 820.

According to the first amalgamation example 810, if the car 804 moves quickly toward the person 802, the apparatus 100 may generate a car crash between the person 802 and car 804 as an amalgamation object.

According to the second amalgamation example 820, if the car 804 slowly moves toward the person marker 802, the apparatus 100 may generate a person 802 riding in a car 804 as an amalgamation object.

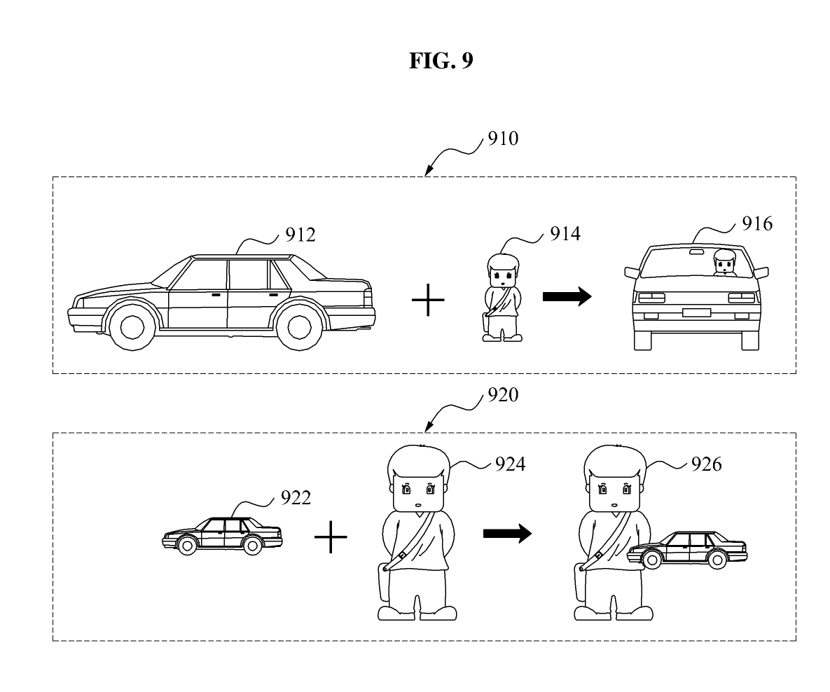

FIG. 9 illustrates amalgamation of objects based on sizes of the objects in an apparatus to provide AR according to an exemplary embodiment of the invention.

Referring to FIG. 9, the apparatus 100 may enable a process of an amalgamated object to change depending on sizes of markers, as shown in a first amalgamation example 910 and a second amalgamation example 920.

According to the first amalgamation example 910, if a relatively larger car marker 912 and a relatively smaller person marker 914 are amalgamated, in which the car 912 is larger than the person 914, the apparatus 100 may generate an amalgamation object 916 indicating a person riding in a car.

According to the second amalgamation example 920, if a relatively smaller car marker 922 and a relatively larger person marker 924 are amalgamated, in which the car 922 is smaller than the person 924, the apparatus 100 may generate an amalgamation object 926 indicating a person holding a toy car.

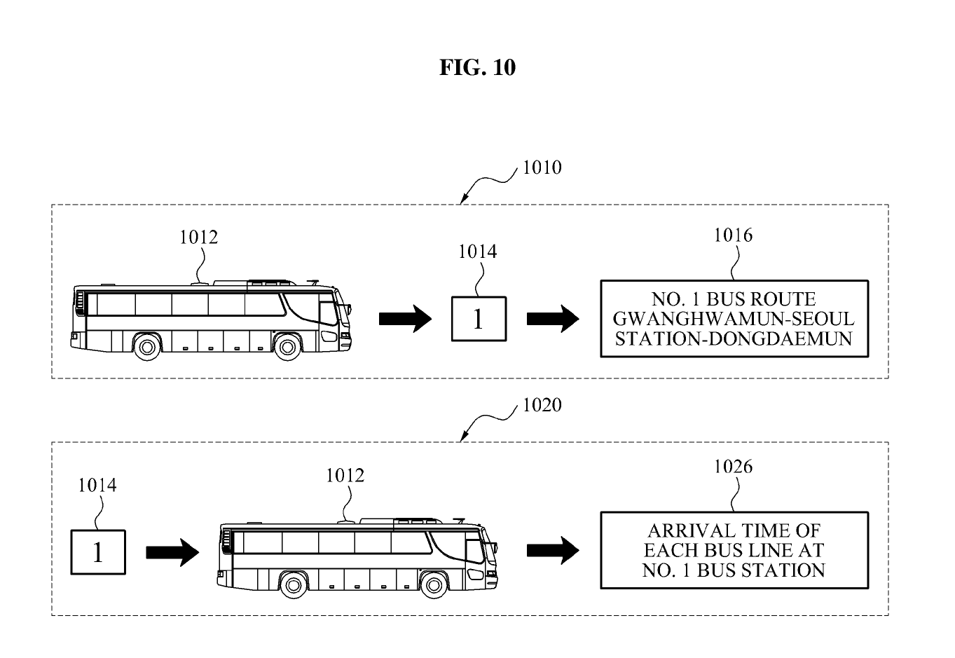

FIG. 10 illustrates amalgamation of objects based on a recognition order of the objects in an apparatus to provide AR according to an exemplary embodiment of the invention.

Referring to FIG. 10, the AR apparatus 100 may enable multiple objects to be amalgamated in a particular manner based on a recognition order of the objects. As shown in FIG. 10, a marker 1012 indicating a bus and a marker 1014 indicating number ‘1’, as a first amalgamation example 1010 and a second amalgamation example 1020.

According to the first amalgamation example 910, if the bus marker 1012 is first recognized and the number marker 1014 is then subsequently recognized, the apparatus 100 may amalgamate the bus marker 1012 and the number marker 1014 to generate an amalgamated object 1016, in which the number marker 1014 indicates the bus number and the corresponding route for the respective bus number.

According to the second amalgamation example 920, if the number marker 1014 is first recognized and the bus marker 1012 is then subsequently recognized, the apparatus 100 may amalgamate the number marker 1014 and the bus marker 1012 to generate an amalgamated object 1026, in which the number marker 1014 indicates the arrival time of each bus at a bus station that bus marker 1012 is heading towards.

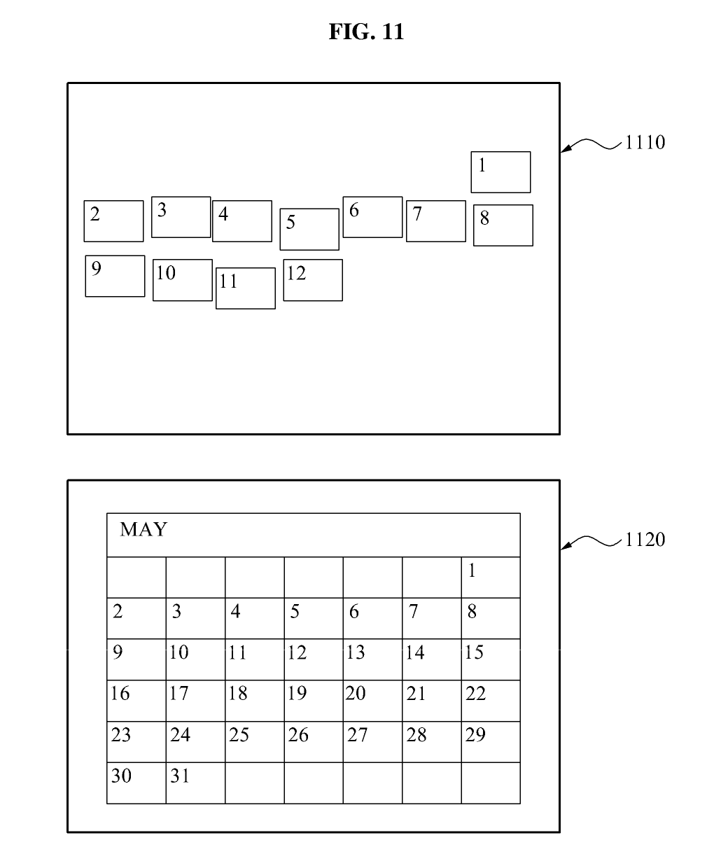

FIG. 11 illustrates amalgamation of objects based on a physical arrangement of the objects in an apparatus to provide AR according to an exemplary embodiment of the invention.

Referring to FIG. 11, the apparatus 100 may detect an arrangement of a plurality of number markers in an image 1110 and may output a corresponding calendar-type amalgamated object 1120 in AR.

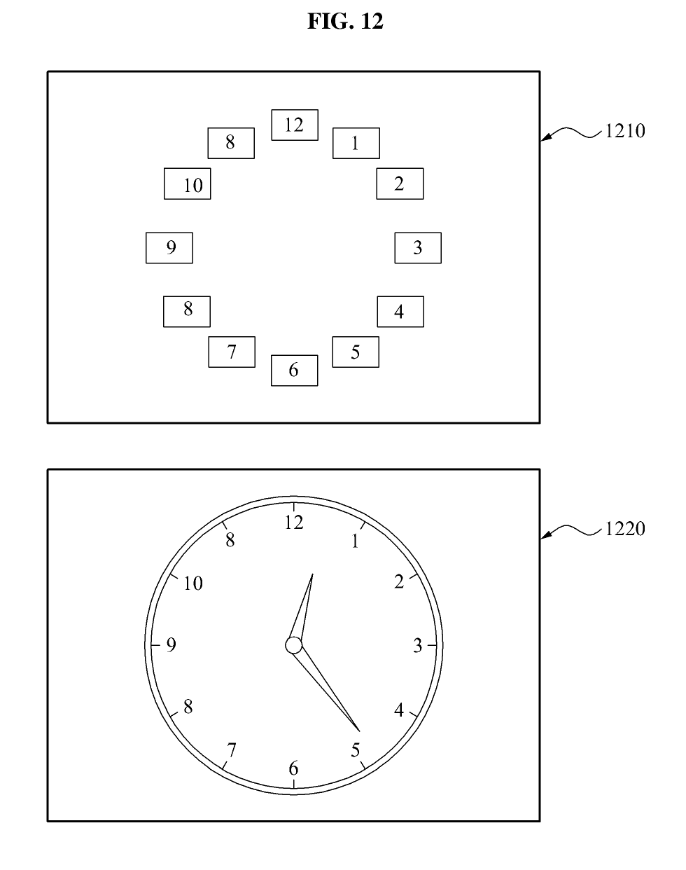

FIG. 12 illustrates amalgamation of objects based on a physical arrangement of the objects in an apparatus to provide AR according to an exemplary embodiment of the invention.

Referring to FIG. 12, the apparatus 100 may detect a circular arrangement of a plurality of number markers in an image 1210 and may output a corresponding clock-type amalgamated object 1220 in AR.

Although the provided examples illustrated in FIG. 4, FIG. 5, FIG. 6, FIG. 7, FIG. 8, FIG. 9, FIG. 10, FIG. 11, and FIG. 12 shows an amalgamated object assembled by multiple markers or multiple markerless objects only for sake of simplicity in disclosure, similar interaction may be provided between a marker and a markerless object, multiple markers, or between multiple markerless objects.

According to embodiments of the present invention, apparatus and a method for amalgamating markers or markerless objects and displaying an amalgamated object in AR may enable attributes and object information of the markers or markerless objects to interact with each other if the respective objects are amalgamated. Accordingly, the interaction of attributes and object information of the marker and markerless object making up the amalgamated object may eliminate the need to generate a database to store an amalgamation pattern of the markers and markerless objects. Also, if a new object is generated, it is possible to amalgamate a new marker or markerless object and an existing marker or markerless object using attributes and object information of the markers or markerless objects thereof without adding an output pattern for an amalgamation pattern of the respective markers or markerless objects. Accordingly, database usage may be reduced and processes of objects may be expanded.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to provide augmented reality (AR), the apparatus comprising:
a marker recognition unit to recognize a first object and a second object in reality information;
an amalgamation determining unit to determine whether the first object and the second object are amalgamated;
an amalgamation processing unit to determine an attribute of each of the recognized objects using an amalgamation pattern of the recognized objects, and to generate an amalgamated object based on the determined attributes; and
an object processing unit to map the amalgamated object to the reality information and to display the mapped amalgamated object.

2. The apparatus of claim 1, wherein reality information comprises location information associated with a real-world, the location information comprising at least one of an address, a geographic location, an image of the real-world, and a travel direction to identify a location in the real-world.

3. The apparatus of claim 1, wherein the first object and the second object are either a marker or a markerless object.

4. The apparatus of claim 3, wherein the marker is an AR tag or a virtual object found in AR, and the markerless object is an object in a real-world.

5. The apparatus of claim 1, wherein the amalgamation pattern comprises at least one of a partial amalgamation, a contact point-type amalgamation, an unified amalgamation, a plural amalgamation, a predicted amalgamation, and a sequent amalgamation.

6. The apparatus of claim 1, wherein the attribute of the first object or the second object comprises at least one of a priority, a feature of the object, and a relationship with the other object.

7. The apparatus of claim 1, wherein the amalgamation determining unit determines amalgamation between a marker and another marker, a marker and a markerless object, or a markerless object and another markerless object.

8. The apparatus of claim 1, wherein the amalgamation determining unit determines amalgamation using at least one of an amalgamation pattern of the recognized objects and object information of the recognized objects.

9. The apparatus of claim 1, further comprising:
an input unit to receive a user input,
wherein the amalgamation processing unit generates the amalgamated object based on the received user input.

10. The apparatus of claim 1, further comprising:
a sensor to collect contextual information applied to the augmented reality,
wherein the amalgamation processing unit generates the amalgamated object based on the contextual information.

11. The apparatus of claim 10, wherein contextual information comprises at least one of information related to temperature, humidity, location, orientation, and acceleration.

12. The apparatus of claim 10, wherein the sensor comprises at least one of a temperature sensor, a humidity sensor, a location sensor, and an orientation measuring sensor.

13. The apparatus of claim 1, wherein the amalgamation processing unit determines a process of the amalgamated object based on the determined attribute, and the object processing unit displays the process of the amalgamated object.

14. The apparatus of claim 1, further comprising a database to store amalgamation information comprising at least one of the amalgamation pattern, the attributes of the objects, the amalgamated object itself, and a process of the amalgamated object.

15. A method for amalgamating objects in augmented reality (AR), the method comprising:
recognizing a first object and a second object in reality information;
determining whether the first object and second object are amalgamated;
determining an attribute of each of the recognized objects using an amalgamation pattern of the recognized objects and object information of the recognized objects;
generating an amalgamated object based on the determined attribute;
mapping the amalgamated object to the reality information; and
displaying the mapped amalgamated object.

16. The method of claim 15, wherein the first object and the second object is either a marker or a markerless object.

17. The method of claim 15, further comprising:
receiving a user input,
wherein the generating an amalgamated object comprises generating an amalgamated object based on the received user input.

18. The method of claim 15, further comprising:
collecting contextual information,
wherein the generating an amalgamated object comprises generating an amalgamated object based on the contextual information.

19. The method of claim 15, further comprising:
determining a process of the amalgamated object based on the determined attribute,
wherein the displaying the mapped amalgamated object comprises displaying the process of the amalgamated object.

20. A method for amalgamating objects in augmented reality (AR), the method comprising:
recognizing a first object and a second object in reality information, wherein reality information comprises a location information associated with a real-world, the location information comprising at least one of an address, a geographic location, an image of the real-world, and a travel direction to identify a location in the real-world;
determining whether the first object and second object are amalgamated;
determining an attribute of each of the recognized objects using an amalgamation pattern of the recognized objects, wherein the attribute of the first object or the second object comprises at least one of a priority, a feature of the object, and a relationship with the other object;
determining a process of the amalgamated object based on the determined attribute;
generating an amalgamated object based on the determined attribute;
mapping the amalgamated object to the reality information; and
displaying the mapped amalgamated object.
